(19) United States
(12) Patent Application Publication
(10) Pub. No.: US 2003/0062424 A1
(43) Pub. Date: Apr. 3, 2003

(54) Two-way cylinder for a snow-gun assembly

(75) Inventors: Vernon McKinney, Alberta (CA); Gheorghe Popa, Alberta (CA)

Correspondence Address: MILLEN, WHITE, ZELANO & BRANIGAN, P.C., 2200 CLARENDON BLVD., SUITE 1400, ARLINGTON, VA, 22201, US

(73) Assignee: McKINNEY INDUSTRIES, INC., Alberta (CA)

(21) Appl. No.: 10/115,941

(22) Filed: Apr. 5, 2002

Related U.S. Application Data
(63) Continuation of application No. 09/584,733, filed on Jun. 1, 2000, now abandoned.

(30) Foreign Application Priority Data
May 19, 2000 (CA) 2,309,070

(51) Int. Cl. B05B 15/06; F25C 3/04; A62C 31/24

(52) U.S. Cl. 239/14.2; 239/280; 239/280.5

(57) ABSTRACT

A two-way hydraulic cylinder assembly which is operated in “pump up” or “pump down” modes is used to position a boom/tower unit having a snow gun at the end of the boom. The assembly has a third “locked” that prevents any hydraulic fluid flow. In the pump down mode, the assembly is capable of automatically routing hydraulic fluid flow to enable the unit to free fall if its weight and gravity force is greater than an opposing force. In a specific embodiment, the cylinder assembly includes a two-way hydraulic cylinder which is attached to a tank forming a hydraulic fluid reservoir. A manual reciprocable pump is connected by a first one-way conduit to the reservoir when the pump is on the fill stroke. A second conduit partly connects the pump outlet on a discharge stroke with a first end chamber of the cylinder to lengthen the cylinder and connects the second end chamber with the reservoir. A third conduit partly connects the pump outlet on a discharge stroke with a second end chamber to shorten the cylinder, and to connect the first end chamber with the reservoir. A fourth conduit partly connects one cylinder end chamber on one side of the piston with the other end chamber on the other side of the piston and with the reservoir; and a distributor valve selectively routes hydraulic fluid through the various conduits as appropriate to achieve the three modes of operation.

### FIELD OF THE INVENTION

The present invention relates to a two-way cylinder assembly. The assembly is connected between the support post turret and the pivoting boom/tower unit of a snow gun assembly, used to make artificial snow on a ski hill. The cylinder assembly is operative to raise or lower the boom/tower unit.

### BACKGROUND OF THE INVENTION

A snow gun assembly typically comprises a sturdy support post extending up from the ground in which it is partly buried. A sleeve, referred to as a turret, is rotatably and coaxially mounted on the top end of the post. A boom is pivotally mounted between its ends to the turret. The boom carries a ‘tower’. The tower comprises air and water conduits for supplying separate streams of pressurized air and water. Together the boom and tower form a boom/tower unit (“B/T unit”). A snow gun or ‘nozzle head’ is attached to the upper end of the tower. The nozzle head forms extensions of the air and water conduits. It also comprises pairs of co-operating air and water outlets which deliver intersecting air jets and water sprays. The air atomizes the water into a plume of fine water droplets. As they fall to the ground through the freezing atmosphere from the elevated nozzle head, the droplets form artificial snow.

Ski runs are commonly equipped with snow gun assemblies at spaced intervals. A ski hill, having multiple runs, might have a hundred snow gun assemblies.

In the course of a night when making artificial snow, many of the snow gun assemblies may have their pivoting B/T units raised or lowered, sometimes more than once. This may be done for any of several reasons, such as:

adjusting the elevation of the nozzle head to suit weather conditions, particularly the wind condition; or

changing out nozzles to provide nozzles of a size better suited to current temperature conditions; or

clearing ice out of the nozzles.

The raising or lowering of the B/T units involves physical effort and consumes the time of the ski hill crew. So the speed and ease with which the unit may be raised or lowered is a significant factor in the operation of a ski hill.

One can characterize the prior art devices for raising or lowering the B/T unit into two types. One type, commonly used in North America, is referred to as the “ratchet binder”. It is essentially a screw jack pivotally connected between the turret and the B/T unit. The ski hill crew worker turns the screw to positively raise or lower the unit. The other type of device, commonly used in Europe, is referred to as the “two-way cylinder”. This device involves a hydraulic fluid reservoir tank bolted to the turret. External hoses and control valves connect the tank with a two-way hydraulic cylinder. The cylinder is pivotally connected between the turret and B/T unit. A small manual pump draws fluid from the reservoir and functions to extend or contract the cylinder, as required.

Both of the ratchet binder and two-way cylinder prior art devices have to be manually actuated or driven throughout the course of moving the B/T unit between initial and final positions. As stated, this takes time and physical effort. Typically it might take a minute of steady screw turning or pump reciprocation to carry out the re-positioning.

There is a need to be able to positively drive the B/T unit during the lowering operation—however positive drive is not required at all in some situations or may commonly only be needed during the first few seconds of the lowering operation.

The need for “positive pump down” capability arises because the back thrust of fluid moving under pressure through the nozzles may prevent the B/T unit from “free falling” or the wind may impede or prevent the upwardly angled B/T unit from dropping. However once the ratchet binder or two-way cylinder starts the B/T unit on its downward descent, gravity acting on the heavy unit will often overcome the counter forces and the unit is then capable of “free fall” on its own. The prior art devices are not able to convert to a neutral mode and allow the unit to “free fall” quickly until stopped at the desired lower position.

As previously mentioned, the prior art two-way cylinder device incorporates external hoses or lines connecting the reservoir with the cylinder. These hoses or lines can get damaged by falling ice.

With this background in mind, it is therefore one object of the present invention to provide a hydraulic two-way cylinder assembly which is adapted to automatically convert to a free fall mode when appropriate during the lowering process.

It is a preferred object to provide a self-contained two-way cylinder in which the hydraulic fluid flow lines are internally housed to minimize damage thereof.

### SUMMARY OF THE INVENTION

In accordance with the invention there is provided a two-way hydraulic cylinder assembly which can be operated in “pump up” or “pump down” modes. That is, it can be pumped to positively raise or lower the B/T unit as required. The assembly can also be “locked” to prevent any hydraulic fluid flow. In the pump down mode, the assembly is also capable of automatically routing hydraulic fluid flow in such a manner as to enable the B/T unit to free fall if its weight and gravity force is greater than the opposing force (which can arise from the wind and/or recoil thrust). In addition, the cylinder assembly is preferably “self-contained” in the sense that the hydraulic fluid conduits and control valve means are internally housed and are not subject to damage by falling ice.

More specifically, the cylinder assembly comprises:

a two-way hydraulic cylinder having a sealed piston and rod working within the cylinder chamber and dividing the chamber into first and second end chambers;

a tank forming a hydraulic fluid reservoir;

a reciprocable pump, which preferably is manually operated in the course of fill and discharge strokes;

a first one-way conduit means for connecting the pump with the reservoir when the pump is on the fill stroke;

second conduit means for partly connecting the pump outlet on a discharge stroke with a first end chamber of the cylinder to bias the piston to lengthen the cylinder and to connect the second end chamber with the reservoir;

third conduit means for partly connecting the pump outlet on a discharge stroke with the second end chamber, to bias the piston to shorten the cylinder, and to connect the first end chamber with the reservoir;

a fourth conduit means for partly connecting one cylinder end chamber on one side of the piston with the other end chamber on the other side of the piston and with the reservoir; and

a distributor valve for selectively routing hydraulic fluid through the various conduits as appropriate to achieve the three modes of: (1) positive “pump up”; positive “pump down” associated with free fall capability; and “lock”.

This cylinder assembly is advantageous in that the worker, in the course of lowering the B/T unit, can initiate the process by pumping for a few seconds until the unit weight and gravity take over and cause the unit to begin free falling—at this point the worker can stop pumping and the unit will lower at relatively high speed until stopped by turning the valve to the locking position. As a consequence, the B/T unit can often be fully lowered in a few seconds with minimal pumping.

Preferably, the cylinder assembly is a “self-contained” unit in that:

a tank surrounds the cylinder lengthwise, to form an annular hydraulic fluid reservoir;

the second and third conduits partly extend through the reservoir;

a block, forming passageways to assist in providing the conduits, is attached to the cylinder, pump and reservoir tank at one end, remote from the rod end of the cylinder; and

a valve, more preferably a rotatable shaft, having suitable sealed connecting passageways for selectively completing the conduits, forms part of the block.

This assembly forms a generally cylindrical outer wall with the valving and conduits internal of the wall where they are protected against damage.

### DESCRIPTION OF THE DRAWINGS

FIGS. 1a, 1b and 1c are side views of a snow gun assembly in raised, partly raised and lowered states;

FIG. 2 is a side view showing a two-way cylinder in accordance with the invention, pivotally connected between the turret and a B/T unit;

FIG. 3 is a sectional side view of a cylinder assembly in accordance with the invention;

FIG. 4 is a plan view of the distributor block and pump of the cylinder assembly;

FIG. 5 is a partly sectional view of the distribution valve;

FIG. 6 is an end view of one end of the distribution valve;

FIG. 7 is an end view of the other end of the distribution valve;

FIG. 8 is a partly sectional side view of the distributor valve;

FIG. 8a is a sectional view of the distributor valve along line A-A of FIG. 8;

FIG. 8b is a sectional view of the distributor valve along line B-B of FIG. 8;

FIG. 8c is a sectional view of the distributor valve along line C-C of FIG. 8;

FIG. 9 is an end view of the distributor block or valve body of FIG. 4;

FIG. 9a is a sectional side view along line A-A of FIG. 9;

FIG. 9b is a sectional side view along line B-B of FIG. 9;

FIG. 9c is a sectional side view along line C-C of FIG. 9;

FIG. 9d is a sectional side view along line D-D of FIG. 9;

FIG. 9e is a sectional end view along line E-E of FIG. 9;

FIG. 9f is a sectional end view along line F-F of FIG. 9;

FIG. 9g is a sectional end view along line G-G of FIG. 9;

FIG. 9h is a side view of the valve body of FIG. 9;

FIG. 9j is a side view of the valve body of FIG. 9;

FIG. 9i is a sectional end view along the line H-H of FIG. 9j;

FIG. 9k is a top plan view of the valve body of FIG. 9;

FIG. 9l is a view of the bottom of the valve body of FIG. 9 ;

FIG. 10a is a partly sectional side view of the valve;

FIG. 10b is a sectional end view along the line X of FIG. 10a;

FIG. 10c is a sectional end view along the line B-B of FIG. 10a;

FIG. 11a is a sectional plan view of the cylinder assembly showing operating conduits and fluid flow on the fill stroke when pumping;

FIG. 11b is a side sectional view of the pump end of the cylinder assembly during the fill stroke;

FIG. 12a is a sectional plan view of the cylinder assembly showing operating conduits and fluid flow on the discharge stroke when pumping;

FIG. 12b is a side sectional view of the pump end of the cylinder assembly during the discharge stroke;

FIG. 13a is a sectional plan view of the cylinder assembly showing operating conduits and fluid flow in the pump up mode;

FIG. 13b is a sectional view of the pump end of the cylinder assembly in the pump up mode;

FIG. 13c is a schematic of the fluid circuit in the pump up mode;

FIG. 14a is a plan view of the cylinder assembly in the locked mode;

FIG. 14b is a schematic of the fluid circuit in the locked mode;

FIG. 15a is a plan view of the cylinder assembly in the release mode during pumping down when the weight of the B/T unit in conjunction with gravity overcomes opposing force;

FIG. 15b is a schematic of the fluid circuit in the release mode;

FIG. 16a is a plan view of the cylinder assembly in the pump down mode;

FIG. 16b is a sectional view of the pump end of the cylinder assembly in the pump down mode; and

FIG. 16c is a schematic of the fluid flow circuit in the pump down mode;

FIGS. 17 and 18 are schematics of the fluid flow circuit.

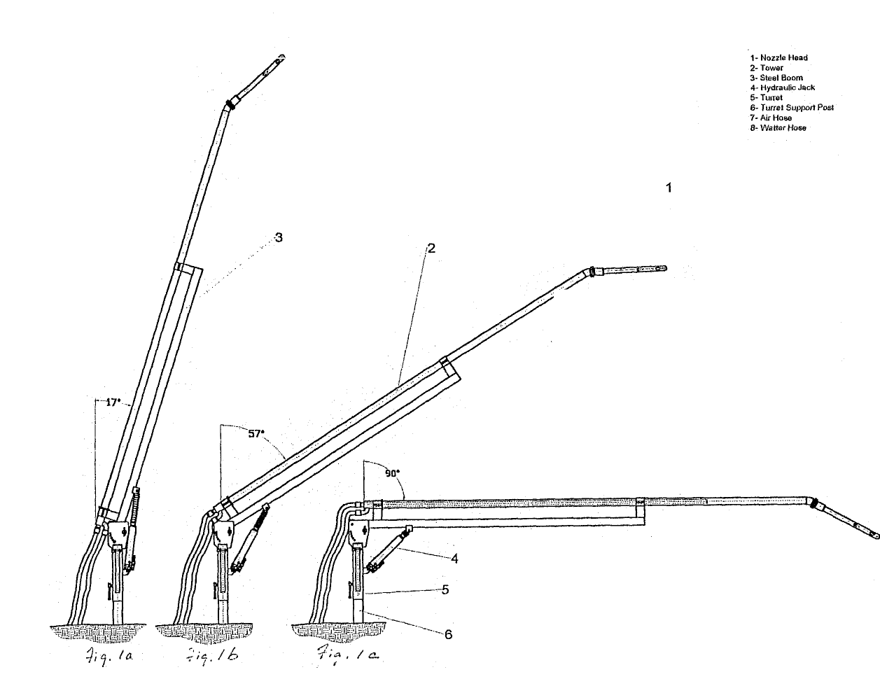

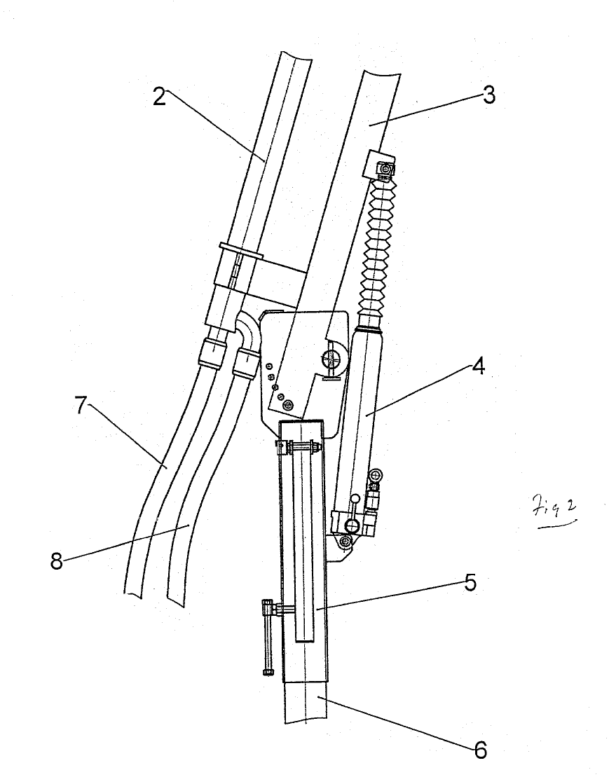

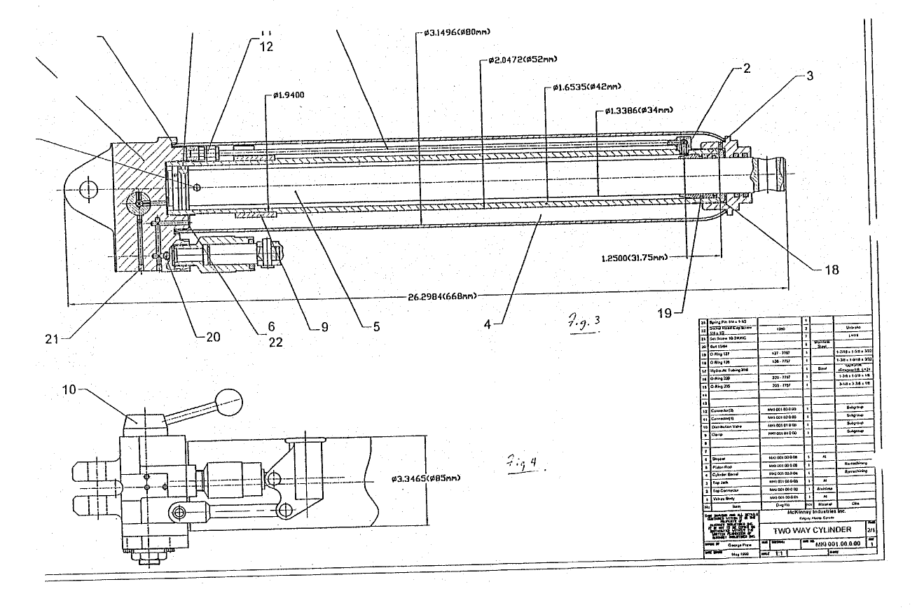

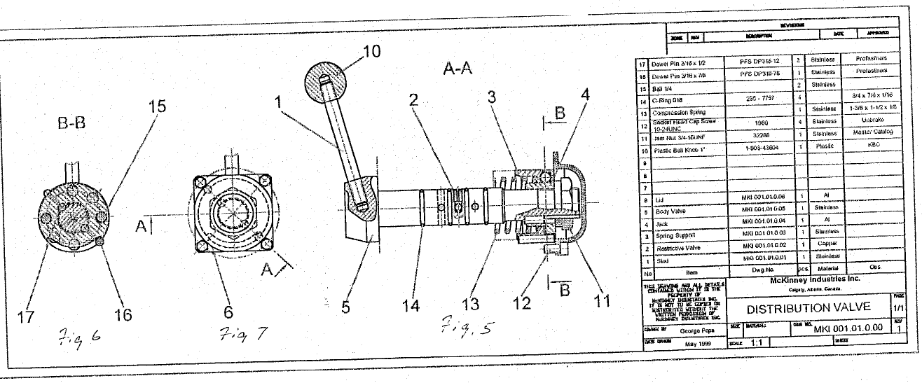

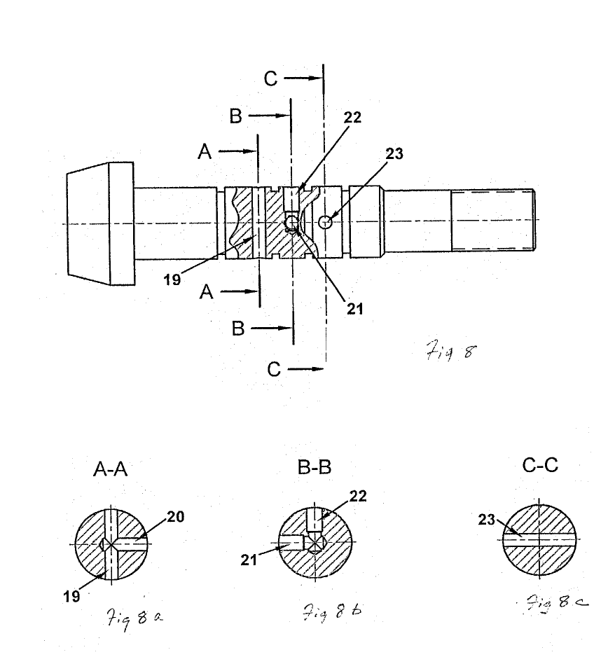

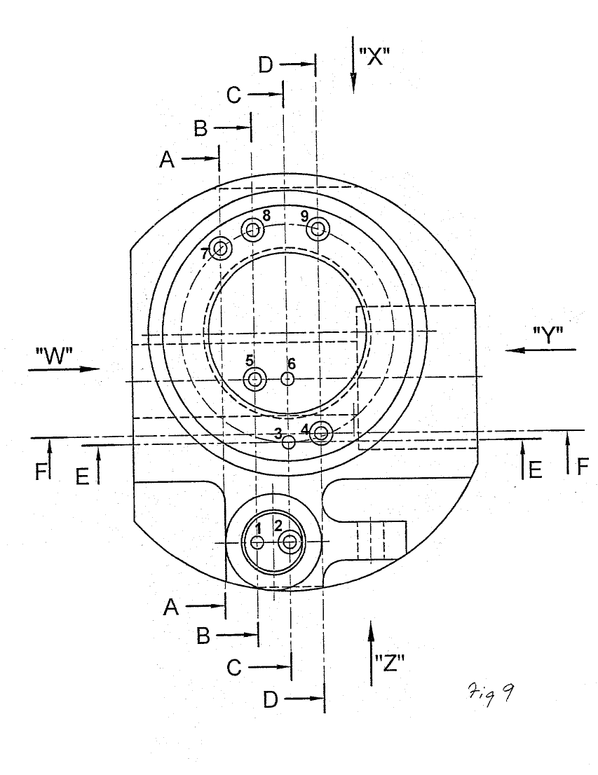

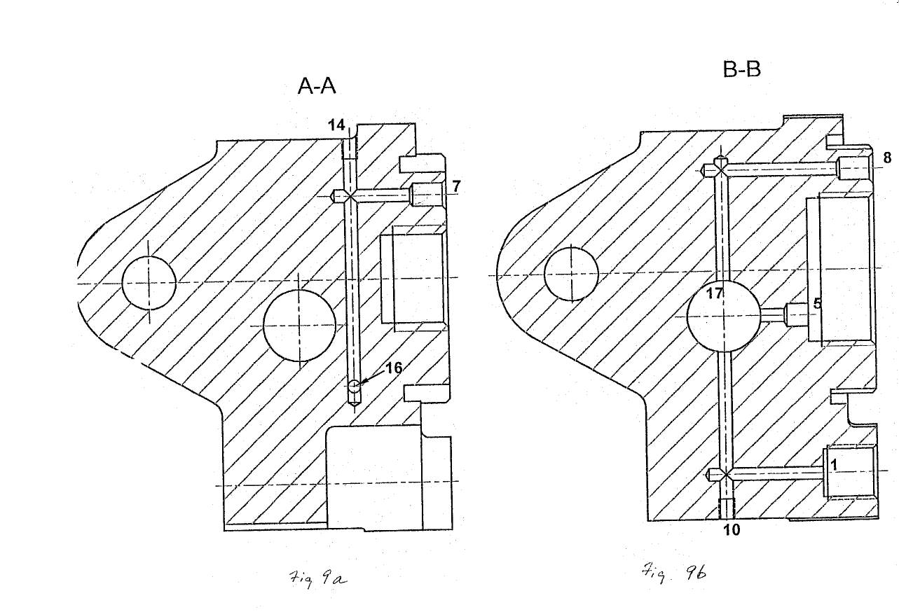

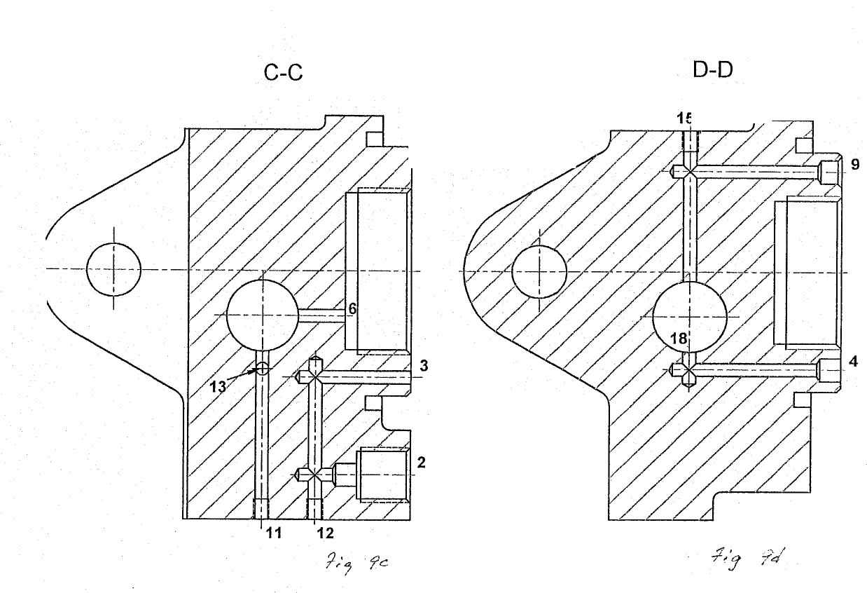

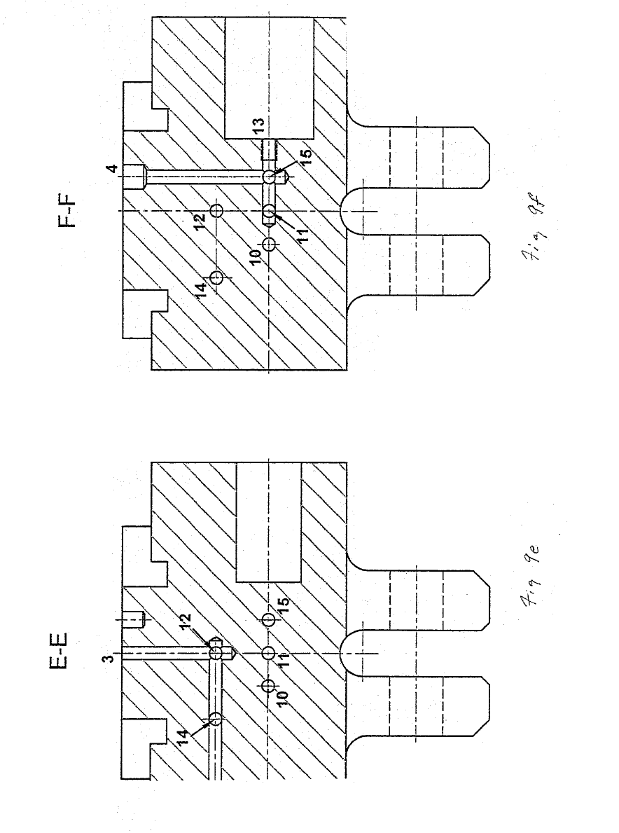

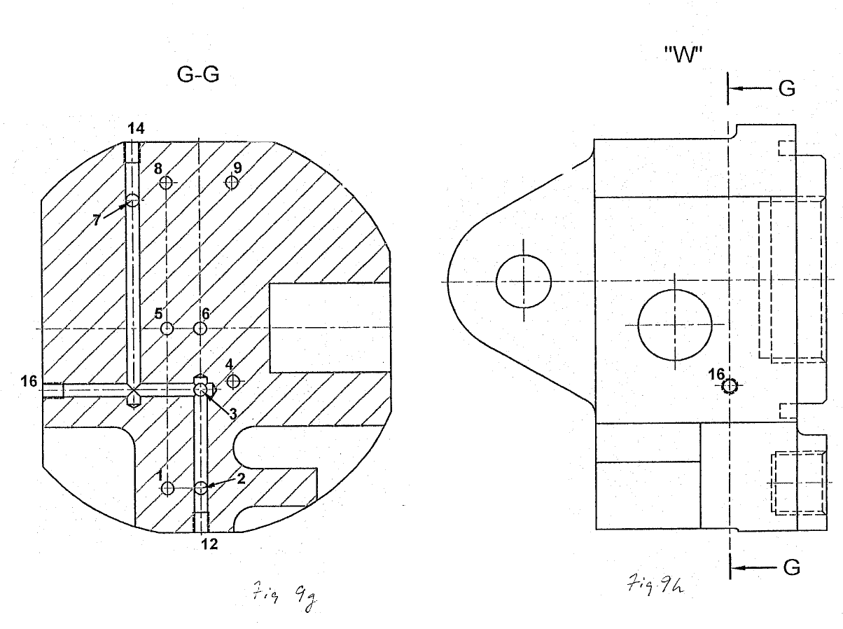

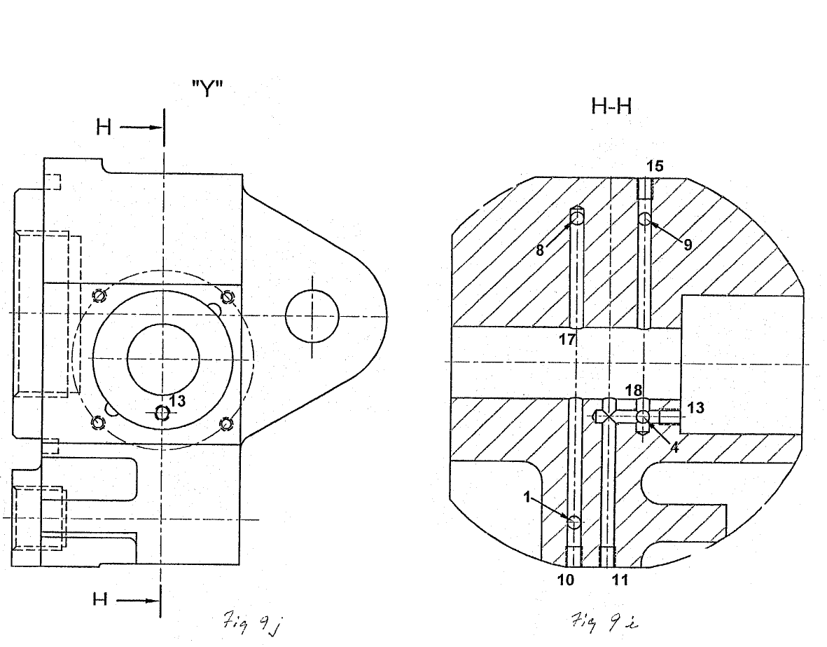

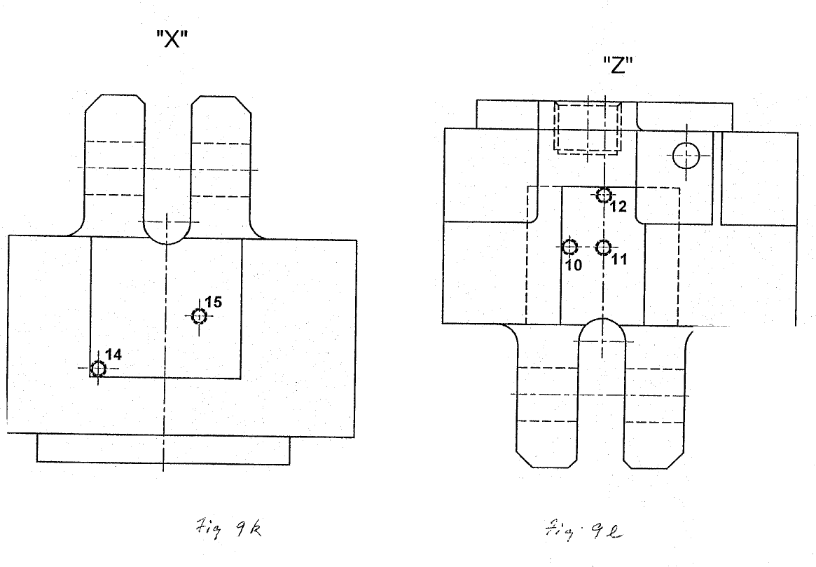

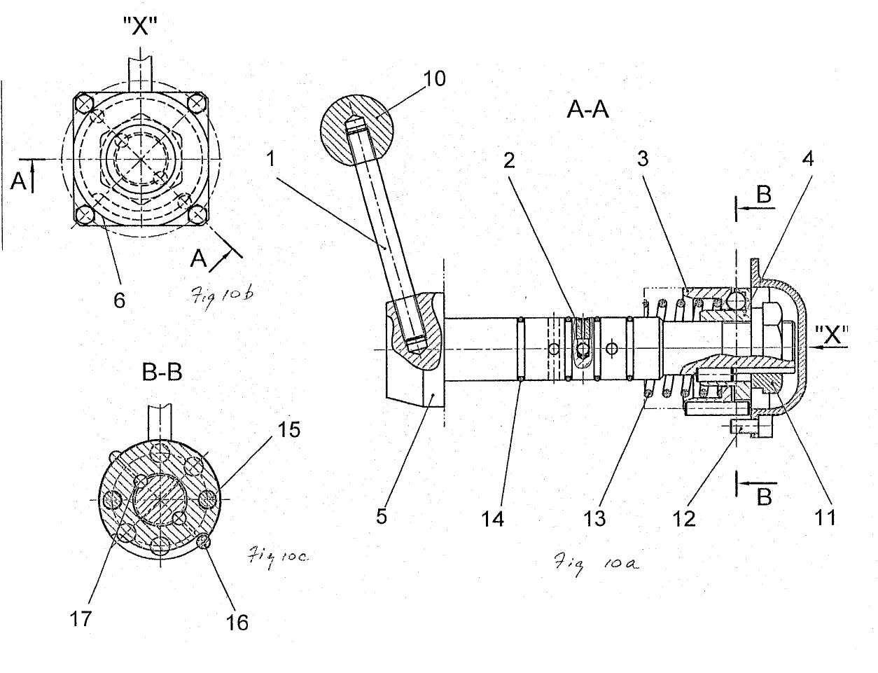

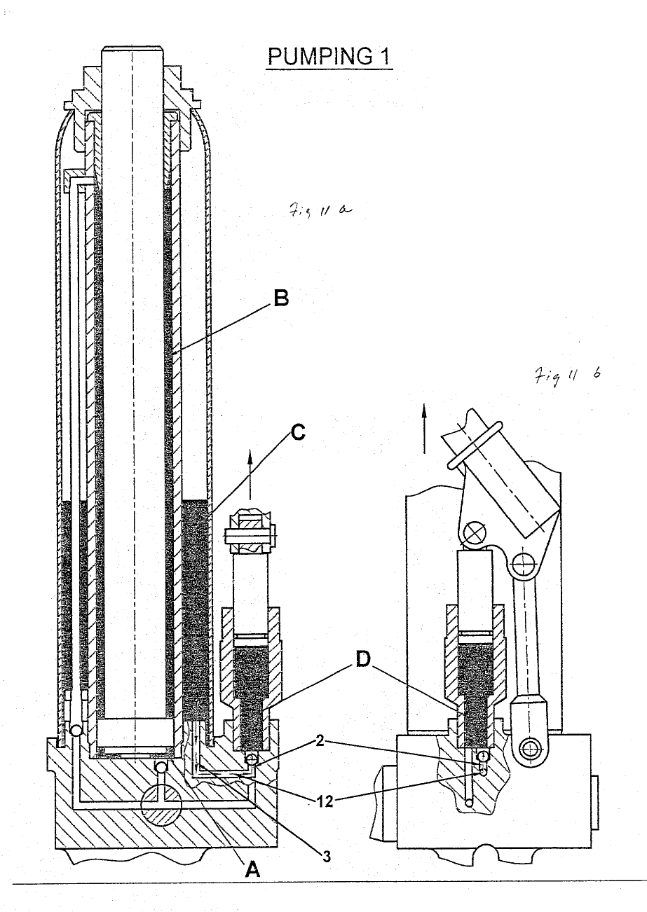

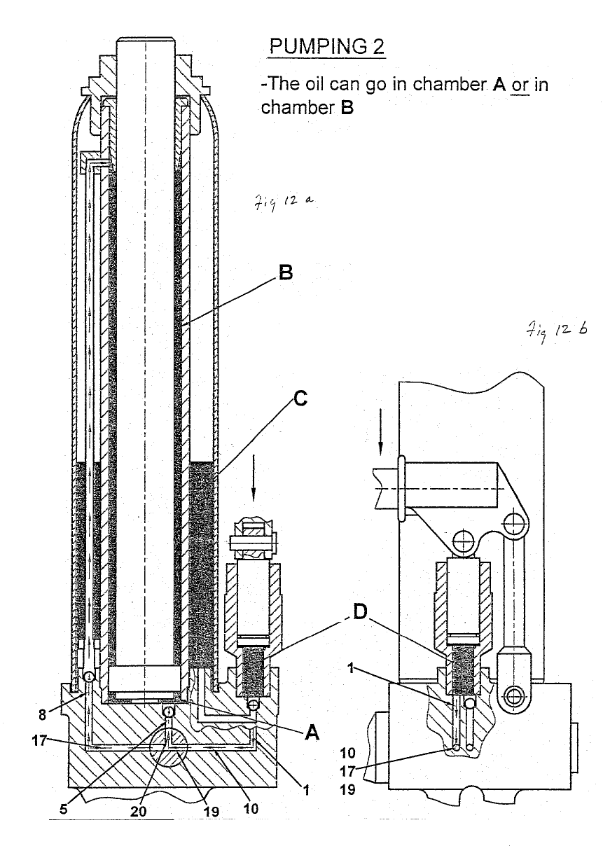

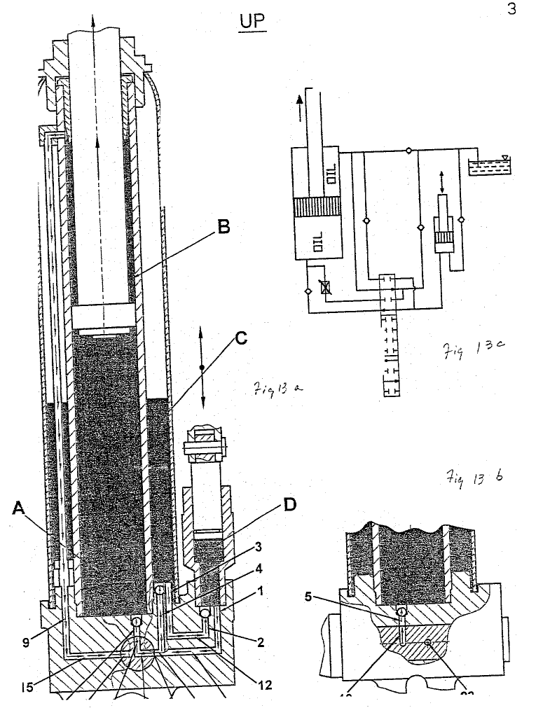

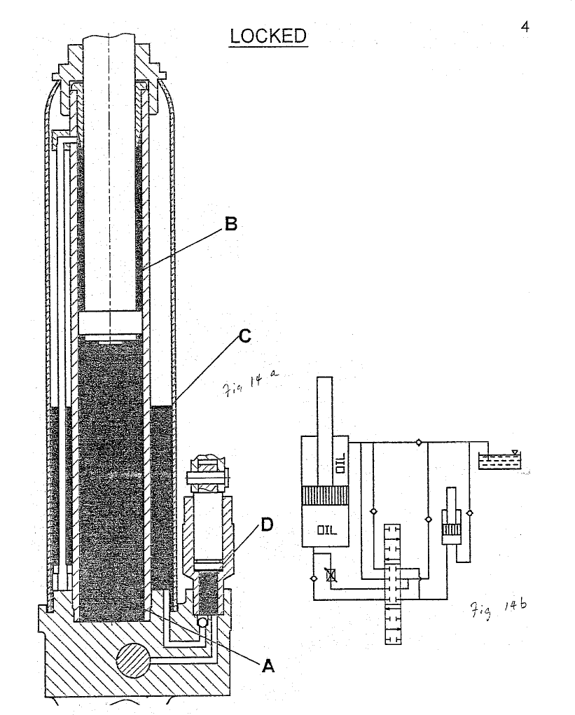

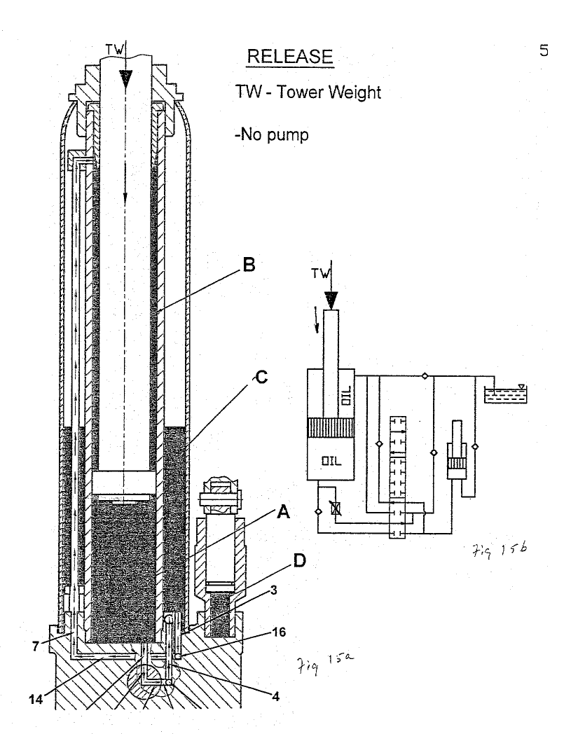

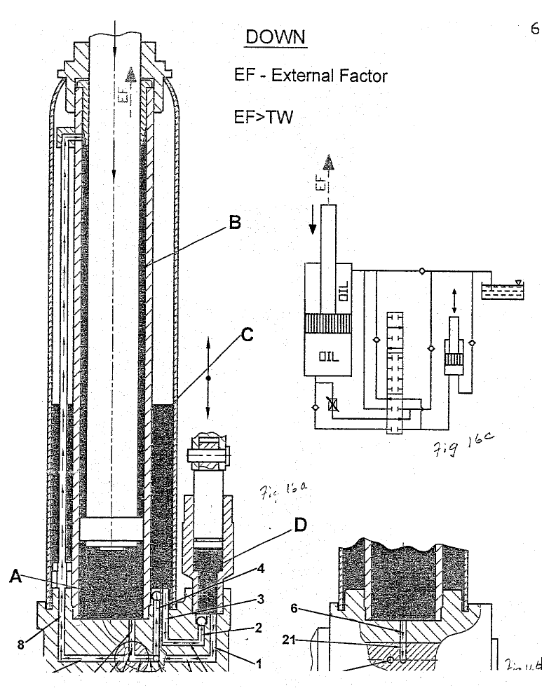

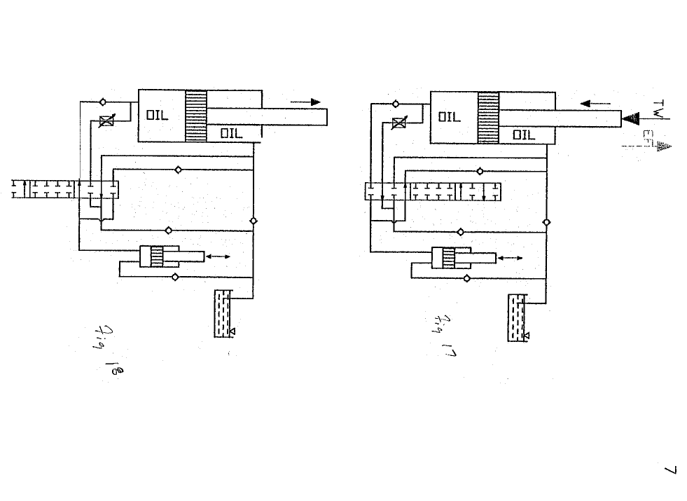

### DESCRIPTION OF THE PREFERED EMBODIMENT

Pump Up

Oil Flow Path

PRESSURE SIDE: FROM CHAMBER “C”, THROUGH “3”, “12”, “2”, CHAMBER “D”, “1”, “10”, “20”, “19”, “5”, AND INTO CHAMBER “A”.

DISPLACED OIL: FROM CHAMBER “B”, THROUGH “9”, “15”, “23”, “18” “4”, AND INTO CHAMBER “C”.

Free Fall Release

Oil Flow Path

DISPLACED OIL: FROM CHAMBER “A”, THROUGH “6”, “21”, “22”, “11”, “13”, “4”, AND INTO CHAMBER “C”.

FROM CHAMBER “C”, THROUGH “3”, “16”, “14”, “7”, AND INTO CHAMBER “B”.

Pump Down

Oil Flow Path

PRESSURE SIDE: FROM CHAMBER “C”, THROUGH “3”, “12”, “2”, CHAMBER “D”, “1”, “10”, “19”, “17”, “8”, AND INTO CHAMBER “B”.

DISPLACED OIL: FROM CHAMBER “A”, THROUGH “6”, “21”, “22”, “11:”, “13”, “4”, AND INTO CHAMBER “C”

The Embodiments of the invention in which an exclusive property or privilege is claimed are defined as follows:

1. A cylinder assembly for raising and lowering the pivoting boom/tower unit of a snow gun assembly having a turret and boom, comprising:
a two-way hydraulic cylinder having a barrel forming a barrel chamber and a piston and rod movable along the chamber to lengthen or shorten the cylinder, the piston dividing the barrel chamber into first and second end chambers;
a reciprocable pump operative to draw in a charge of hydraulic fluid on a fill stroke and to expel it on a discharge stroke, the pump having an inlet and an outlet;
a tank forming a reservoir chamber for containing hydraulic fluid;
first one-way conduit means for connecting the reservoir with the pump inlet for the supply of hydraulic fluid thereto on the fill stroke;
second conduit means for partly connecting the pump outlet on a discharge stroke with the first end chamber, to bias the piston to lengthen the cylinder, and to connect the second end chamber with the reservoir;
third conduit means for partly connecting the pump outlet on a discharge stroke with the second end chamber, to bias the piston to shorten the cylinder, and to connect the first end chamber with the reservoir;
fourth conduit means for partly connecting the second end chamber with the first end chamber and the reservoir; and
adjustable valve means for selectively completing appropriate conduit means as required to enable a positive pump up mode of operation, a positive pump down mode of operation with free fall capability, and a lock mode.

2. A cylinder assembly comprising:
a two-way hydraulic cylinder;
a tank forming a reservoir chamber for containing hydraulic fluid;
a pump for pumping hydraulic fluid from the reservoir chamber;
first conduit means for partly connecting the pump with the first end of the cylinder chamber for lengthening the cylinder and for connecting the other end of the cylinder chamber with the reservoir during a pump up mode;
second conduit means for partly connecting the pump with the second end of the cylinder chamber for shortening the cylinder and for connecting the first and second chamber ends with the reservoir during a pump down mode; and
adjustable valve means for selectively completing one of the conduit means and alternately for blocking fluid flow.
